(19) United States
(12) Patent Application Publication
(10) Pub. No.: US 2022/0225810 A1
(43) Pub. Date: Jul. 21, 2022

(54) Safebox

(71) Applicant: Nicholas Anthony Mack, Bowie, MD (US)

(72) Inventor: Nicholas Anthony Mack, Bowie, MD (US)

(21) Appl. No.: 17/151,627

(22) Filed: Jan. 18, 2021

(30) Foreign Application Priority Data
Jan. 18, 2021 (US) 17151627

(51) Int. Cl. A47G 29/20; A47G 29/14; G07C 9/20

(52) U.S. Cl. CPC A47G 29/20; G07C 9/20; A47G 29/141

(57) ABSTRACT

The Safebox is a weatherproof box with an airtight seal between the top lid and the body of the box to keep any outside liquids from getting inside. The Safebox is used for safely and securely protecting package(s) when delivered and the owner cannot physically take and claim his/or her item(s). It will require a valid delivery person to open with a key and safely leave the package(s) inside and the property owner will access their package(s) with a custom code.

The Safebox is a weatherproof material with a keypad and keyhole on the front of the box. Between the lid and the body of the box there will be an airtight seal to protect any outside liquid substances entering inside the Safebox.

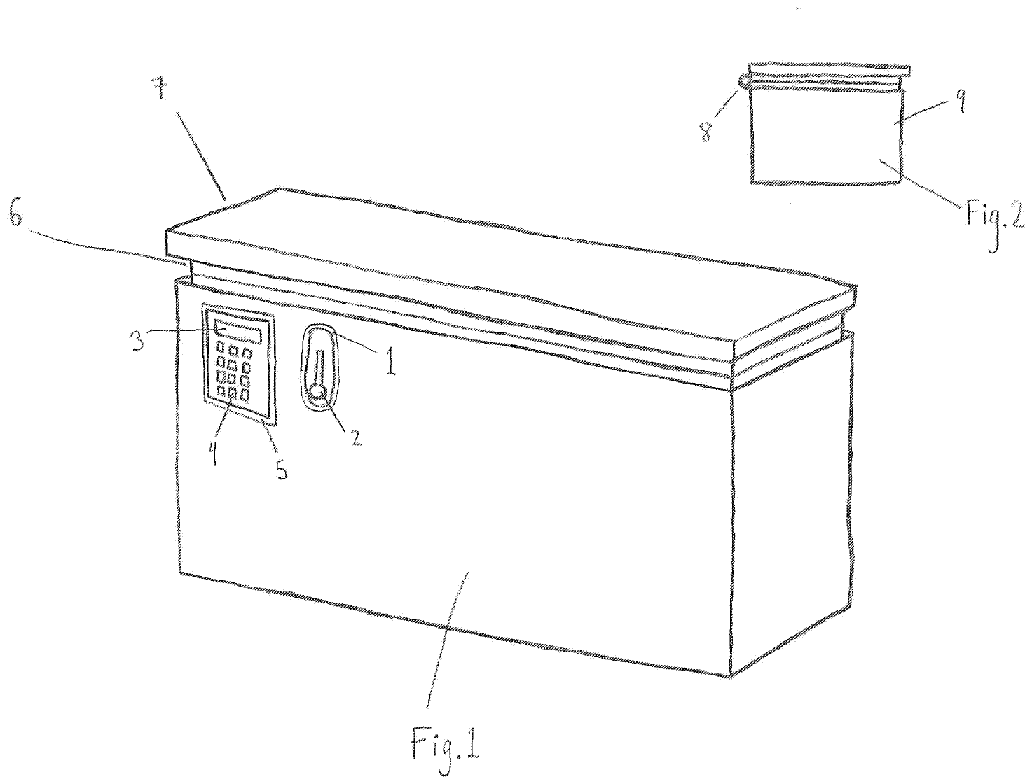

On the drawing there are two perspectives of the Safebox which are labeled FIG. 1 and FIG. 2. For FIG. 1 it is a 3D image view of the Safebox and within the image are detailed numbers pointing at each role played in FIG. 1. On FIG. 1 there is #3 which is the screen of the keypad, #4 is the numbered keypad buttons, and #5 is the frame of the keypad. For #2 it is a keyhole for opening the box and #1 is a frame of the keyhole. For #6 is the airtight seal that protects any outside liquids from getting inside and #7 is the top lid of the Safebox. For FIG. 2 it is a side view perspective of the Safebox and #8 is an open and closing axle to let the lid of the box to be opened and closed and #9 is the body part of the Safebox to sit package(s) inside.

1. I claim the safebox is intended to hold items and/or packages in the safe and secure weatherproof contained box for the property owner to retrieve.
I claim items and/or packages can safely and securely be placed inside the Safebox after using a key to open it and the property owner can access the Safebox with their own custom code through the keypad and retrieve his/or her items/packages and the securely close the lid of the Safebox.
